(19) United States
(12) Patent Application Publication
(10) Pub. No.: US 2024/0245038 A1
(43) Pub. Date: Jul. 25, 2024

(54) NIPPLE DRINKER FOR ANIMAL WATERER WITH COMPOSITE DRINKER TIP

(71) Applicant: GSI Brasil Industria e Comercio de Equipamentos Agropecuarios Ltda, Marau (BR)

(72) Inventors: Emilene Dalmolin, Marau (BR); Fabrício Ferrari, Marau (BR); Robson Pauleto Camargo, Marau (BR); Tiago Bonafe, Marau (BR)

(21) Appl. No.: 18/327,478

(22) Filed: Jun. 1, 2023

Related U.S. Application Data
(63) Continuation-in-part of application No. 29/870,358, filed on Jan. 23, 2023.

(51) Int. Cl. A01K 39/02

(52) U.S. Cl. CPC A01K 39/0213

(57) ABSTRACT

A drinker assembly includes an inlet portion configured to interface with a fluid supply, a drinker tip removably coupled to the inlet portion, the inlet portion and the drinker tip defining a fluid-flow path within an interior of the inlet portion and the drinker tip, an interior surface of the drinker tip defining a sealing surface, a top pin disposed within the fluid-flow path of the inlet portion and drinker tip and at least partially extending into the inlet portion, a bottom pin disposed within the fluid-flow path of the inlet portion and drinker tip and at least partially extending through and out of the drinker tip and a sealing ball disposed between the top pin and the bottom pin and configured to directly abut against the sealing surface of the drinker tip for create a fluid-tight seal.

This application is a continuation-in-part of U.S. design application Ser. No. 29/870,358, filed Jan. 23, 2023.

### TECHNICAL FIELD

This disclosure relates to poultry watering systems, and more particularly to a nipple drinker connectable to a watering line of the watering system that has a variable flow rate.

### BACKGROUND

Nipple drinker watering systems are commonly used to provide water to poultry and other small animals. These watering systems include a supply line which is connected to several branching watering pipes extending the interior length of a house, such as a poultry house. Each watering pipe has a series of spaced apart watering stations or nipple drinkers attached thereto. Nipple drinkers for poultry houses are activated by birds pecking against the nipple drinker to release a supply of water. The watering system is typically suspended from the roof rafters of the poultry house by a suspension system having a motorized winch and cable assembly (not shown) that is selectively operated to allow the watering system to be raised and lowered so that the poultry house may be cleaned and new bedding put down between poultry batches.

The pressure within the water watering pipes is maintained at a suitable (e.g., about 6″-12″ of water) which is typically substantially less than the line pressure (e.g., 30-60 psi) in the supply line. Thus, water regulators are positioned in the watering system before the nipple drinkers. The regulators are usually placed at the beginning of the water watering pipes.

At times, it may be desirable to vary the amount of water released by the nipple drinker 102 when activated by the bird. At present, when farmers need to increase the water volume in a poultry watering line, they turn a lever at the pressure regulator of each line, increasing the pressure and so the water flow rate in each nipple drinker. With the continuous improvement of technology and the diversification of product demand, nipple drinkers having a variable flowrate would be desirable.

### BRIEF SUMMARY

Embodiments include a nipple drinker. The nipple drinker may include a mounting portion configured to removably attach to a watering pipe. The nipple drinker may also include a drinker assembly coupled to the mounting portion and including a inlet portion configured to extend into a fluid-flow channel within the watering line, a top pin extending at least partially into the inlet portion, a sealing ball vertically below the top pin, a bottom pin vertically below the sealing ball, and a drinker tip configured to engage the mounting portion and to secure the sealing ball and the bottom pin within the drinker assembly, where the drinker tip defines a inner surface against which the sealing ball is configured to abut against to create an at least substantially fluid-tight seal.

The drinker tip may include a single unitary body.

The nipple assembly may not include a distinct sealing bushing.

The drinker tip may include a composite material.

The inner surface may include a cylindrical surface.

The inner surface may include a stepped-cylindrical surface.

The composite material may include polyphenylene sulfide, carbon fiber, graphite, and polytetrafluorethylene.

The composite material may include, by volume, at least 60 percent polyphenylene sulfide.

The composite material may include, by volume, about 65 percent polyphenylene sulfide, about 15 percent carbon fibers, about 10 percent graphite, and about 10 percent polytetrafluorethylene.

Each cylindrical step of the stepped-cylindrical surface may define an edge at a transition from a riser portion of the given cylindrical step to a tread portion of the given cylindrical step.

The sealing ball may be configured to rest on the edge of a single cylindrical step of the stepped-cylindrical surface.

The edge may include a chamfer edge.

The chamfer edge may define an at least substantially frusto-conical surface.

The chamfer edge may define an at least substantially frusto-spherical surface.

One or more embodiments include a watering system having a supply line and a plurality of watering lines in fluid communication with the supply line. The watering system may also include a plurality of nipple drinkers coupled to each watering line of the plurality of watering lines, where each nipple drinker includes a mounting portion removably attached to a respective watering line and a drinker assembly coupled to the mounting portion. The drinker assembly may include a inlet portion into a fluid-flow channel within the watering line, a top pin extending at least partially into the nipple inlet, a sealing ball vertically below the top pin, a bottom pin vertically below the sealing ball, and a drinker tip configured to engage the mounting portion and to secure the sealing ball and the bottom pin within the drinker assembly, where the drinker tip includes a composite material and single unitary body, and where the drinker tip defines an inner surface against which the sealing ball is configured to directly abut against to create an at least substantially fluid-tight seal.

The composite material may include polyphenylene sulfide, carbon fiber, graphite, and polytetrafluorethylene.

The inner surface may include a cylindrical surface.

The inner surface may include a stepped-cylindrical surface.

Each cylindrical step of the stepped-cylindrical surface may define an edge at a transition from a riser portion of the given cylindrical step to a tread portion of the given cylindrical step, and the sealing ball may be configured to rest on the edge of a single cylindrical step of the stepped-cylindrical surface.

Some embodiments include a drinker assembly having an inlet portion configured to interface with a fluid supply, a drinker tip removably coupled to the inlet portion, the inlet portion and the drinker tip defining a fluid-flow path within an interior of the inlet portion and the drinker tip, an interior surface of the drinker tip defining a sealing surface, a top pin disposed within the fluid-flow path of the inlet portion and drinker tip and at least partially extending into the inlet portion, a bottom pin disposed within the fluid-flow path of the inlet portion and drinker tip and at least partially extending through and out of the drinker tip, and a sealing ball disposed between the top pin and the bottom pin and configured to abut against the sealing surface of the drinker tip for create a fluid-tight seal.

Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a schematic representation of an animal watering system having a plurality of nipple drinkers;

FIG. 2 shows an exploded, perspective view of one of the nipple drinkers of FIG. 1 in accordance with one or more embodiments;

FIG. 3A shows a perspective view of a top pin of the nipple drinker of FIG. 2;

FIG. 3B shows another perspective view of the top pin of the nipple drinker of FIG. 2;

FIG. 4A shows another embodiment of a top pin of the nipple drinker;

FIG. 4B shows another embodiment of a top pin of the nipple drinker;

FIG. 4C shows another embodiment of a top pin of the nipple drinker;

FIG. 5A shows a cross-sectional view of the nipple drinker with the top pin of FIG. 3A in a first vertical position;

FIG. 5B shows a cross-sectional view of the nipple drinker with the top pin in a second vertical position;

FIG. 5C shows a cross-sectional view of the nipple drinker with the top pin in a third vertical position;

FIG. 6 shows a cross-sectional view of a portion of a nipple drinker according to one or more embodiments; and

FIG. 7 shows an enlarged sectional view of a portion of the nipple drinker;

### DETAILED DESCRIPTION

Illustrations presented herein are not meant to be actual views of any particular nipple drinker, drinker tip, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may ” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” “outer,” “inner,” etc., is used for clarity and convenience in understanding the disclosure and accompanying drawings, and does not connote or depend on any specific preference or order, except where the context clearly indicates otherwise. For example, these terms may refer to an orientation of elements of a nipple drinker and/or a drinker tip as illustrated in the drawings. Additionally, these terms may refer to an orientation of elements of a nipple drinker and/or a drinker tip when utilized in a conventional manners.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise. For example, these terms may refer to an orientation of elements of a dual linear delta assembly and/or linear delta system when utilized in a conventional manner. Furthermore, these terms may refer to an orientation of elements of a dual linear delta assembly and/or linear delta system when as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

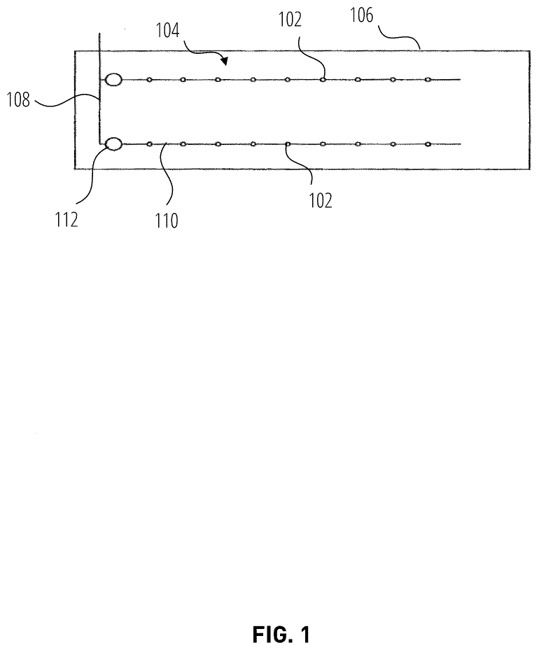

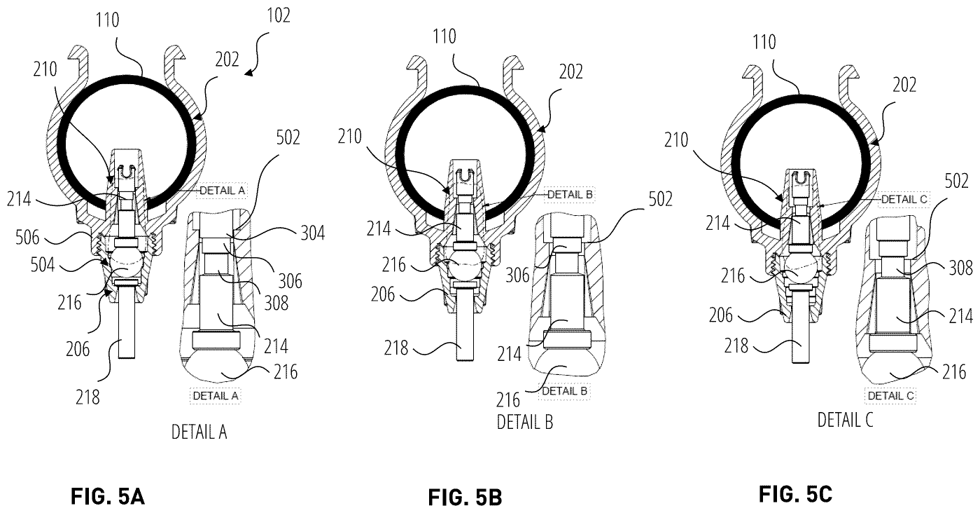

FIG. 1 shows a watering system 104 for use in an animal house such as poultry house 106. The watering system 104 may include a supply line 108, which may be connected to at least one watering line 110. A number of watering stations or nipple drinkers 102 may be spaced along and mounted to each watering line 110. The watering line 110 on which the nipple drinkers 102 are mounted encloses a fluid-flow channel (best seen in FIG. 5A) through which water is carried to each nipple drinker 102. Nipple drinkers 102 for poultry houses 106 may be activated by birds pecking against the nipple drinker 102 to release a supply of water. The pressure within the watering lines 110 may be maintained at a suitable pressure (e.g., about 6″-12″ of water) which is typically substantially less than the line pressure (e.g., 30-60 psi) in the supply line 108. Thus, water regulators 112 may be positioned within the watering system 104 and between the nipple drinkers 102 and the supply line 108. In some embodiments, the regulators 112 are located at the beginning of the water watering lines 110, as schematically shown in FIG. 1. The watering system 104 may be suspended from roof rafters of the poultry house 106 by a suspension system having a manual or a motorized winch and cable assembly (not shown) that is selectively operated to allow the watering system 104 to be raised and lowered so that the poultry house 106 may be cleaned and new bedding put down between poultry batches.

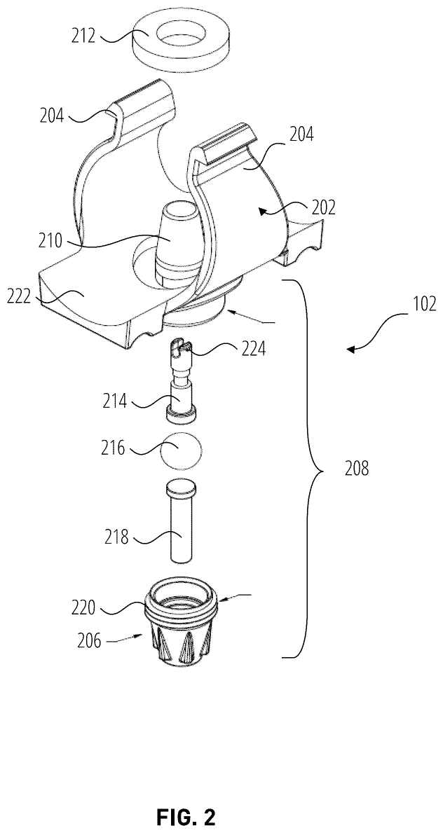

FIG. 2 shows an exploded perspective view of a nipple drinker 102 that may be utilized within the watering system 104 according to one or more embodiments of the present disclosure. The nipple drinker 102 may include a mounting portion 202 that engages the watering line 110 to mount the nipple drinker 102 on the watering pipe. In the illustrated embodiment, the mounting portion 202 may include a base portion 222 and two side arms 204 extending upward from the base portion 222. The two side arms 204 may be configured to at least partially wrap around the watering line 110 to detachably couple the nipple drinker 102 to the watering line 110. For example, the base portion 222 and the two side arms 204 may defined an inner arcuate surface (e.g., cylindrical surface) that at least substantially matches and outer arcuate surface of (e.g., cylindrical surface) the watering line 110.

The nipple drinker 102 may further include a drinker assembly 208 coupled to the base portion 222 of the mounting portion 202. The drinker assembly 208 may include an inlet portion 210, a sealing ring 212, a top pin 214, a sealing ball 216, a bottom pin 218, and a drinker tip 206. The base portion 222 of the mounting portion may define an aperture through which the inlet portion 210 may extend. The inlet portion 210 may be configured to extend into the fluid-flow channel of the watering line 110 through an opening in the watering line 110. In some embodiments, the nipple drinker 102 may further include the sealing ring 212 for disposing between the inlet portion 210 of the drinker assembly 208 and the watering line 110. The sealing ring 212 may be configured to create a fluid-tight seal between the drinker assembly 208 and the watering line 110. In some embodiments, the inlet portion 210 may form a unitary body with the mounting portion 202. In additional embodiments, the inlet portion 210 may be separate and distinct from the mounting portion 202.

The drinker assembly 208 may define an interior fluid-flow path, which may provide a fluid pathway from the fluid-flow channel of the watering line 110 to the drinker tip 206 of the drinker assembly 208. The top pin 214 may be configured to selectively allow a flow of a fluid (e.g., water) from the watering line 110 and out the drinker tip 206 of the nipple drinker 102. The sealing ball 216 may be disposed adjacent to the top pin 214 along the interior fluid-flow channel of the drinker assembly 208, and the bottom pin 218 may be disposed adjacent to the sealing ball 216 along the interior fluid-flow channel of the drinker assembly 208. In view of the foregoing, the top pin 214 may extend at least partially into the inlet portion, the sealing ball 216 may be disposed vertically below the top pin 214, the bottom pin 218 may be disposed vertically below the sealing ball 216, and the drinker tip (e.g., nipple) may be configured to engage the mounting portion 202 and secure the top pin 214, the sealing ball 216, and the bottom pin 218 within the drinker assembly 208. In some embodiments, the top pin 214 may include a fiberglass composite and/or a thermoplastic.

As is described in greater detail below, during operation, the sealing ball 216 may be configured to seat against at least a portion of an inner surface 504 (shown in FIG. 5A) of the drinker tip 206, and the bottom pin 218 may be configured to extend out of the drinker tip 206 such that the bottom pin 218 may be exposed to animals (e.g., birds). When the sealing ball 216 is seated against the inner surface 504, the sealing ball 216 may at least substantially outward flow of fluid through the drinker tip 206 of the nipple drinker 102. The sealing ball 216 can be displaced from the inner surface 504 of the drinker tip 206 by the bottom pin 218 when an animal presses against the bottom pin 218 desiring to utilize the nipple drinker 102. In particular, the bottom pin 218 is configured to move the sealing ball 216 away (e.g., upward) from the inner surface 504 of the drinker tip 206. Moreover, moving the sealing ball 216 away from the sealing surface may cause the top pin 214 to move upward relative the drinker assembly 208 to create a pathway that allows fluid to flow from the fluid-flow channel of the watering line 110 and into the nipple drinker 102.

The drinker tip 206 may be configured to hold the bottom pin 218, the sealing ball 216, and the top pin 214 within the drinker assembly 208. Furthermore, the drinker tip 206 may be removably coupled to the inlet portion 210. For example, the drinker tip 206 may include a threaded portion 220 configured to engage with a correlating threaded portion 506 (FIG. 5A) of the base portion 222 of the mounting portion 202. In some embodiments, threads of the threaded portion 220 of the drinker tip 206 may extend radially outward from an outer surface of the drinker tip 206. For instance, the threaded portion 220 may include outward extending threads. For clarity, the top pin 214 may be held within the mounting portion 202 via one or more catch members 224 extending radially outward from the top pin 214. For example, the catch members 224 may engage one or more portions of the mounting portion 202.

During operation, when the watering line 110 is pressurized with fluid, the sealing ball 216 may be pushed against the sealing surface of the drinker tip 206 by the fluid pressure. Causing the sealing ball 216 to be pushed against the inner surface 504 of the drinker tip 206 may form an at least substantially fluid-tight seal to prevent unintentional leakage of fluid out through the nipple drinker 102. Furthermore, when an animal needs to drink, the animal may peck (e.g., push) at the bottom pin 218 and cause the bottom pin 218 to vertically displace the sealing ball 216 from the inner surface 504 of the drinker tip 206. With the sealing ball 216 is temporarily separated from the inner surface 504 of the drinker tip 206, fluid may flow through a fluid pathway of the top pin 214, around the sealing ball 216, and through the drinker tip 206 of the nipple drinker 102 along the bottom pin 218 to provide fluid to the animal.

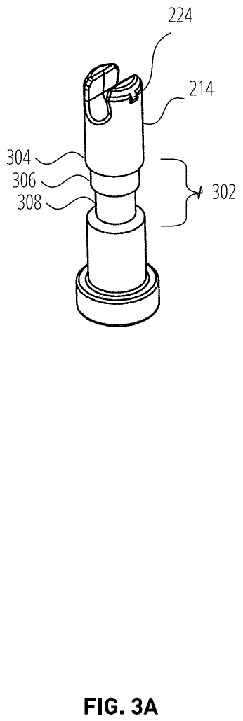

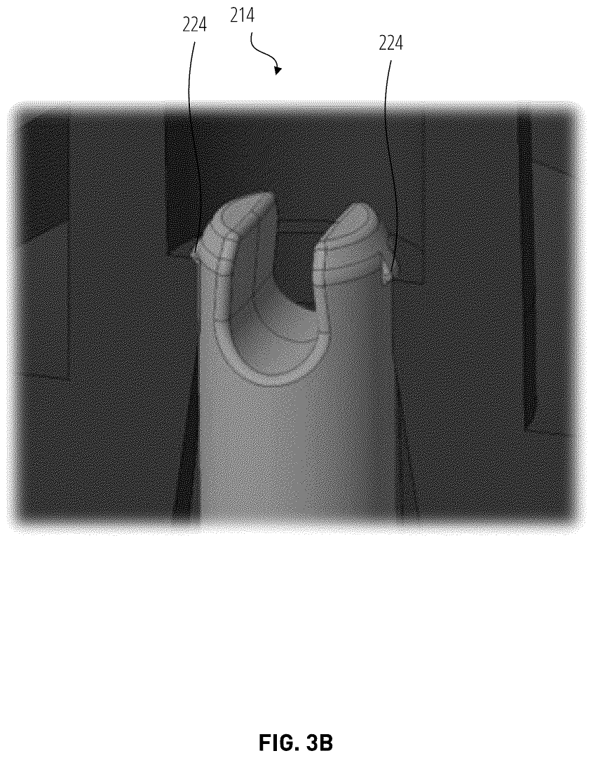

Referring to FIG. 3A and FIG. 3B, in some embodiments, the top pin 214 may include a flow control section 302 along a portion of the longitudinal length of the top pin 214. The flow control section 302 may include a plurality of vertically spaced flow control features that control the amount of fluid (e.g., water) that flows through the nipple drinker 102. In some embodiments, the flow control features may include section of the top pin 214 that have differing (e.g., variable) diameters. As discussed above, as an animal moves the bottom pin 218, the movement causes a vertical movement of the top pin 214. The vertical movement of the top pin 214 changes the flowrate through the nipple drinker 102 because of the difference in diameter existing in the body of the top pin 214. For instance, the cross-sectional area of the fluid pathway around the top pin 214 is dependent on a diameter of the top pin 214 exposed to the fluid channel of the watering line 110.

In the embodiment shown in FIG. 3A, the flow control section 302 may include a first flow feature 304 having a first diameter, a second flow feature 306 having a second diameter that is smaller than the first diameter, and a third flow feature 308 having a third diameter that is smaller than the second diameter. The third flow feature 308 is closest to the sealing ball 216 and the first flow feature 304 is closest to the inlet portion 210. This embodiment of the top pin 214 allows three different flowrates due to the varying geometry of the flow control section 302 and its dimensional differences that can be positioned to interact with a portion of the interior of the drinker assembly 208 to control the flowrate. While the illustrated embodiment shows a top pin 214 that has three flow features 304, 306 and 308, one skilled in the art will understand that the top pin 214 could have a different number of flow features to provide a different number of flowrates.

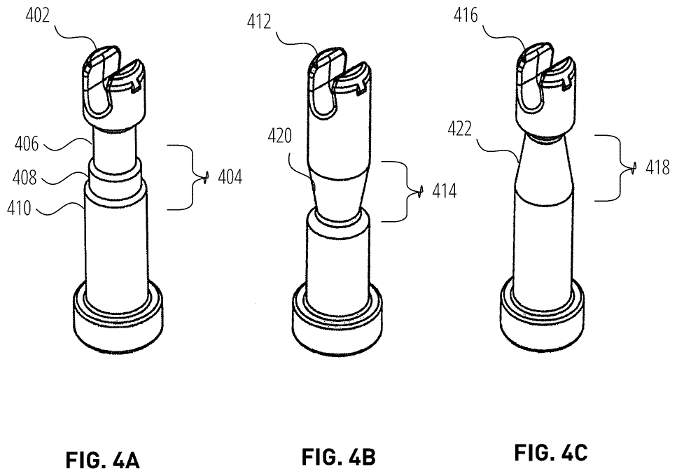

FIG. 4A, FIG. 4B and FIG. 4C show different embodiments of top pins having flow control sections that allow different flow characteristics. In FIG. 4A, the top pin 402 includes a flow control section 404 with a first flow feature 406 having a first diameter, a second flow feature 408 having a second diameter that is larger than the first diameter, and a third flow feature 410 having a third diameter that is larger than the second diameter. In this embodiment, the third flow feature 410 is closest to the sealing ball 216 and the first flow feature 406 is closest to the inlet portion 210. FIG. 4B shows a top pin 412 that includes a flow control section 414 having a progressive or ramped change in diameter rather than stepped changes such as the top pins 214 and 402 described above. In this embodiment, the flow control section 414 of top pin 412 has a smaller diameter closest to the sealing ball 216 and a larger diameter closest to the inlet portion 210. FIG. 4C shows a top pin 416 that has a flow control section 418 that also has a ramped change in diameter, but in this embodiment, the flow control section 418 has a larger diameter closest to the sealing ball 216 and a smaller diameter closest to the inlet portion 210.

FIG. 5A, FIG. 5B and FIG. 5C depict the nipple drinker 102 showing the top pin 214 in three different vertical positions such that the flow control section 302 is aligned to provide three different flowrates through the nipple drinker 102. FIG. 5A illustrates the top pin 214 vertically positioned by movement of the bottom pin 218 such that the first flow feature 304 in the flow control section 302 interfaces with a flow determining shelf 502 in the drinker assembly 208. As best seen in the Detail A portion of FIG. 5A, the flow determining shelf 502 is formed in the drinker assembly 208 so as to interact with the flow control section 302 of the top pin 214 in such a way as to form the limiting feature in the fluid passageway and thus the flowrate through the nipple drinker 102. As best seen in the enlarged detail A section of FIG. 5A, the first flow feature 304 has the largest diameter, the space between the first flow feature 304 and the flow determining shelf 502 is the smallest and the first flowrate is correspondingly small.

FIG. 5B illustrates a second condition where additional movement of the bottom pin 218 causes additional upward movement of the top pin 214 relative the flow determining shelf 502 such that the second flow feature 306 now interfaces with the flow determining shelf 502. Since the second flow feature 306 has a smaller diameter than the first flow feature 304, the flow channel past the flow determining shelf 502 allows for a second flow rate that is greater than the first flow rate.

FIG. 5C illustrates a third condition where yet additional movement of the bottom pin 218 causes additional upward movement of the top pin 214 such that the third flow feature 308 now interfaces with the flow determining shelf 502. Since the third flow feature 308 has a smaller diameter than the second flow feature 306, the flow channel past the flow determining shelf 502 allows for a third flow rate that is greater than the second flow rate.

Thus, upward vertical movement of the top pin 214 relative the flow determining shelf 502 causes an increase in the flowrate through the nipple drinkers 102.

One skilled in the art will understand that in a different embodiment the top pin 402 illustrated in FIG. 4A may alternatively be used with the drinker assembly 208 such that upward vertical movement of the top pin 402 relative the flow determining shelf 502 causes a decrease in the flowrate through the nipple drinker 102. In this embodiment, upward movement of the top pin 402 successively positions the first flow feature 406, the second flow feature 408 and then the third flow feature 410 of the flow control section 404 to interface with the flow determining shelf 502 to decrease the cross-sectional area of the flow channel past the flow determining shelf 502.

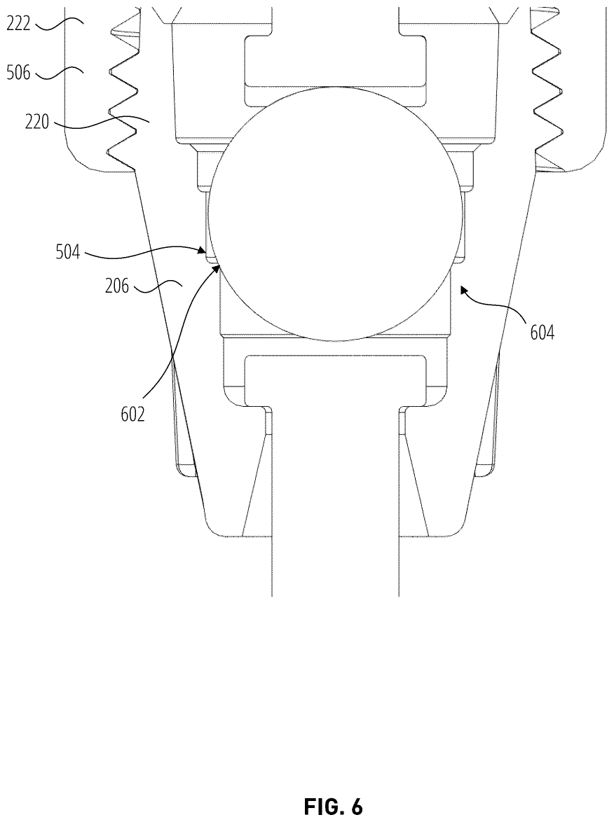

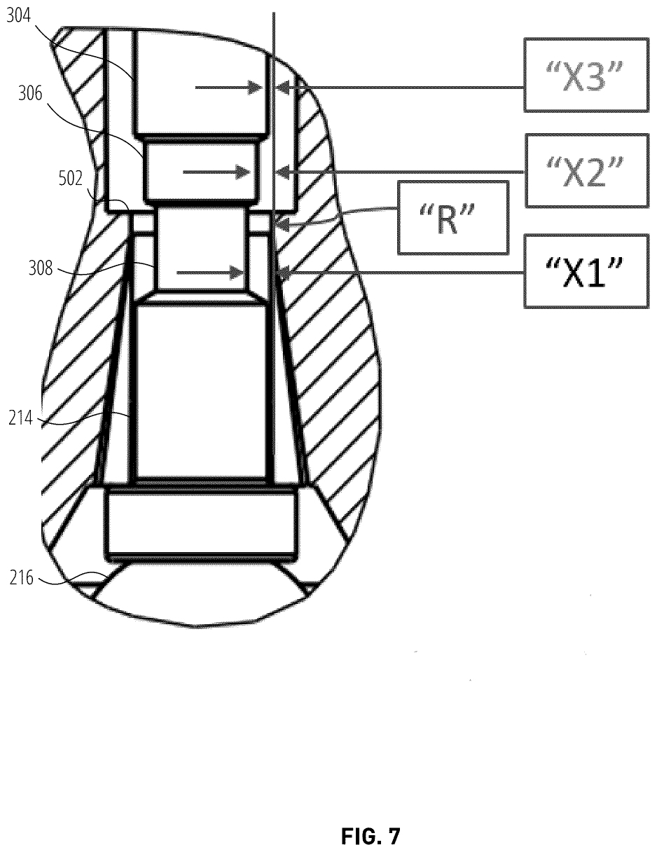

FIG. 6 shows an enlarged cross-sectional view of a portion of the drinker assembly 208 according to one or more embodiments of the disclosure. As discussed above, the drinker tip 206 may define an inner surface 504 against which the sealing ball 216 may press during operation to create an at least substantially fluid-tight seal.

In some embodiments, the inner surface 504 may be defined by an interior surface of the drinker tip 206. In one or more embodiments, the inner surface 504 may include a cylindrical surface. In some embodiments, the inner surface 504 may include a stepped-cylindrical surface defining one or more cylindrical steps extending radially inward, and the sealing ball 216 may be sized and shaped to rest against a cylindrical step 604. For instance, the sealing ball 216 may be sized and shaped to rest against an edge 602 of a cylindrical step 604 (e.g., an interface or transition portion between a tread portion of the cylindrical step 604 and a riser portion of the cylindrical step) of the inner surface 504. For example, the edge 602 may define a sealing surface and/or a sealing edge of the drinker tip 206.

In some embodiments, the edge 602 of the cylindrical step 604 may have a radius of curvature when viewed from the view depicted in FIG. 6. In additional embodiments, the edge 602 of the cylindrical step 604 may include a chamfer edge. In some embodiments, the chamfer edge may define an at least substantially frusto-conical surface. In further embodiments, the chamfer edge may include an arcuate chamfer edge, and the arcuate chamfer edge may define a partial spherical surface (e.g., a frusto-spherical surface).

In some embodiments, the tread portions and the riser portions of the steps of the stepped-cylindrical surface may be sized and shaped such that, when the sealing ball 216 is fully seated within the drinker tip 206, a vertical distance spanned by the sealing ball 216 spans a vertical height of at least one entire step of the stepped-cylindrical surface. In additional embodiments, when the sealing ball 216 is fully seated within the drinker tip 206, a vertical distance spanned by the sealing ball 216 spans a vertical height of a plurality of steps (e.g., two, three, or more steps) of the stepped-cylindrical surface. In some embodiments, the stepped surface may be sized and shaped such that, when the sealing ball 216 is fully seated within the drinker tip 206, the sealing ball 216 is configured to rest against the edge 602 of the cylindrical step 604 and a riser portion of a vertically-adjacent step of the inner surface 504.

Referring still to FIG. 6, because the drinker tip 206 defines the inner surface 504, during operation, the sealing ball 216 may directly contact the inner surface 504 (e.g., the edge 602/sealing surface) of the drinker tip 206. Furthermore, as a result, the drinker assembly 208 may not include a sealing bushing to interface with the sealing ball 216.

A bottommost cylindrical step of the drinker tip 206 may define a substantially planar annular surface upon which the bottom pin 218 may rest when the watering line 110 is pressurized with fluid and an animal is not interacting with the bottom pin 218. As discussed above, the drinker tip 206 may include a threaded portion 220 configured to engage with a correlating threaded portion 506 of the base portion 222 of the mounting portion 202 (FIG. 2).

In some embodiments, threads of the threaded portion 220 of the drinker tip 206 may extend radially outward from an outer surface of the drinker tip 206. For instance, the threaded portion 220 may include outward extending threads. As such, the drinker tip 206 may screw into the base portion 222 of the mounting portion 202 (FIG. 2).

In some embodiments, the drinker tip 206 may include a composite material that is at least substantially wear resistant. For instance, the drinker tip 206 may include composite material include polyphenylene sulfide, carbon fiber, graphite, and polytetrafluorethylene. In some embodiments, the composite material may include, by volume, at least 50 percent polyphenylene sulfide, at least 60 percent polyphenylene sulfide, at least 70 percent polyphenylene sulfide, at least 80 percent polyphenylene sulfide, or at least 90 percent polyphenylene sulfide. As a non-limiting example, the composite material may include, by volume, about 70 percent polyphenylene sulfide, about 10 percent carbon fibers, about 10 percent graphite, and about 10 percent polytetrafluorethylene. In yet further embodiments, the composite material may include, by volume, about 62 percent polyphenylene sulfide, about 30 percent of a combination of carbon fibers and graphite, and about 8 percent polytetrafluorethylene. In yet additional embodiments, the composite material may include, by volume, about 65 percent polyphenylene sulfide, about 15 percent carbon fibers, about 10 percent graphite, and about 10 percent polytetrafluorethylene.

In some embodiments, the drinker tip 206 may be formed via one or more injection molding methods. As a non-limiting example, the drinker tip 206 may be formed via an injection molding method including an injection pressure between 10,000 psi and 15,000 psi (69-103 MPa), a melt temperature between 585° F. and 625° F. (307-329° C.), a mold temperature between 275° F. and 350° F. (135-177° C.), a drying time of about 6 hours at 300° F. (149° C.), and a moisture content of about 0.04 percent.

Referring to FIG. 1 through FIG. 6 together, the drinker assembly 208 of the present disclosure may provide advantages over conventional nipple assemblies. For example, as mentioned above, the drinker assembly 208 of the present disclosure does not require a bushing (e.g., a sealing bushing) for creating a seal with the sealing ball 216. Conventionally, sealing bushings within conventional nipple drinkers include a metal material and/or metal alloy. As such, the metal bushings are subject to corrosion and often fail due to being exposed to water and/or additives within the water, in particular chlorine applied for sanitization purposes. As such, the drinker assembly 208 of the present disclosure provides a more reliable drinker assembly 208 with increased durability in comparison to conventional nipple assemblies and provides a drinker assembly 208 having an increased lifespan relative to conventional nipple assemblies. Furthermore, by removing a piece relative to conventional nipple assemblies, the drinker assembly 208 of the present disclosure includes fewer potential failure points and provides easier assembly and/or replacement. Moreover, by reducing a number of components, the drinker assembly 208 of the present disclosure may lead to cost savings in production and repair. Referring to the top pin 214, due to the one or more catch members 203 extending radially outward from the top pin 21, the top pin 214 may remain coupled to the mounting portion 202 when the drinker tip 206 is detached from the mounting portion 202.

FIG. 7 shows an enlarged, partial side view of the top pin 214 and drinker assembly 208. As depicted in FIG. 7, a change in the cross-sectional area of the top pin 214 along its longitudinal length and within the flow control section 302 of the top pin 214 causes a distance R measured between the inner surface of a flow determining shelf 502 of the drinker assembly 208, which in the illustrated example is the fixed reference formed in the inner surface of the drinker assembly 208, and the top pin 214 to be a variable distance based on the vertical position of the top pin 214 relative to the flow determining shelf 502. In this example, when the top pin 214 is positioned such that the third flow feature 308 interfaces with the flow determining shelf 502, the distance R is equal to X1, when the top pin 214 is moved in an upward direction such that the second flow feature 306 interfaces with the flow determining shelf 502, the distance R is equal to X2, and when the top pin 214 is further moved in the upwards direction such that the first flow feature 304 interfaces with the flow determining shelf 502, the distance R is equal to X3. Furthermore, X3 is less than X2, which is less than X1.

Referring to FIG. 1 through FIG. 7 together, the drinker assembly 208 may include any of the top pins and nipple inlets described in UK Application No. GB2216311.7 and the top pins may interface with the geometry of the nipple assemblies via any of the manners described in the foregoing listed application.

All references cited herein are incorporated herein in their entireties. If there is a conflict between definitions herein and in an incorporated reference, the definition herein shall control.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A nipple drinker, comprising:
a mounting portion configured to removably attach to a watering pipe;
a drinker assembly coupled to the mounting portion and comprising:
an inlet portion configured to extend into a fluid-flow channel within the watering line;
a top pin extending at least partially into the inlet portion;
a sealing ball vertically below the top pin;
a bottom pin vertically below the sealing ball; and
a drinker tip configured to engage the mounting portion and to secure the sealing ball and the bottom pin within the drinker assembly,
wherein the drinker tip defines an inner surface against which the sealing ball is configured to abut against to create an at least substantially fluid-tight seal.

2. The nipple drinker of claim 1, wherein the drinker tip comprises a single unitary body.

3. The nipple drinker of claim 1, wherein the nipple assembly does not include a distinct sealing bushing.

4. The nipple drinker of claim 1, wherein drinker tip comprises a composite material.

5. The nipple drinker of claim 4, wherein the composite material comprises polyphenylene sulfide, carbon fiber, graphite, and polytetrafluorethylene.

6. The nipple drinker of claim 4, wherein the composite material comprises, by volume, at least 60 percent polyphenylene sulfide.

7. The nipple drinker of claim 4, wherein the composite material comprises, by volume, about 65 percent polyphenylene sulfide, about 15 percent carbon fibers, about 10 percent graphite, and about 10 percent polytetrafluorethylene.

8. The nipple drinker of claim 1, wherein the inner surface comprises a cylindrical surface.

9. The nipple drinker of claim 1, wherein the inner surface comprises a stepped-cylindrical surface.

10. The nipple drinker of claim 9, wherein each cylindrical step of the stepped-cylindrical surface defines an edge at a transition from a riser portion of the given cylindrical step to a tread portion of the given cylindrical step.

11. The nipple drinker of claim 10, wherein the sealing ball is configured to rest on the edge of a single cylindrical step of the stepped-cylindrical surface.

12. The nipple drinker of claim 11, wherein the edge comprises a chamfer edge.

13. The nipple drinker of claim 12, wherein the chamfer edge defines an at least substantially frusto-conical surface.

14. The nipple drinker of claim 12, wherein the chamfer edge defines an at least substantially frusto-spherical surface.

15. A watering system comprising:
a supply line;
a plurality of watering lines in fluid communication with the supply line; and
a plurality of nipple drinkers coupled to each watering line of the plurality of watering lines,
wherein each nipple drinker comprises:
a mounting portion removably attached to a respective watering line;
a drinker assembly coupled to the mounting portion and comprising:
an inlet portion into a fluid-flow channel within the watering line;
a top pin extending at least partially into the inlet portion;
a sealing ball vertically below the top pin;
a bottom pin vertically below the sealing ball; and
a drinker tip configured to engage the mounting portion and to secure the sealing ball and the bottom pin within the drinker assembly,
wherein the drinker tip comprises a composite material and single unitary body, and
wherein the drinker tip defines an inner surface against which the sealing ball is configured to directly abut against to create an at least substantially fluid-tight seal.

16. The watering system of claim 15, wherein the composite material comprises polyphenylene sulfide, carbon fiber, graphite, and polytetrafluorethylene.

17. The watering system of claim 15, wherein the inner surface comprises a cylindrical surface.

18. The watering system of claim 15, wherein the inner surface comprises a stepped-cylindrical surface.

19. The watering system of claim 15, wherein each cylindrical step of the stepped-cylindrical surface defines an edge at a transition from a riser portion of the given cylindrical step to a tread portion of the given cylindrical step, and wherein the sealing ball is configured to rest on the edge of a single cylindrical step of the stepped-cylindrical surface.

20. A drinker assembly comprising:
an inlet portion configured to interface with a fluid supply;
a drinker tip removably coupled to the inlet portion, the inlet portion and the drinker tip defining a fluid-flow path within an interior of the inlet portion and the drinker tip, an interior surface of the drinker tip defining a sealing surface;
a top pin disposed within the fluid-flow path of the inlet portion and drinker tip and at least partially extending into the inlet portion;
a bottom pin disposed within the fluid-flow path of the inlet portion and drinker tip and at least partially extending through and out of the drinker tip; and
a sealing ball disposed between the top pin and the bottom pin and configured to abut against the sealing surface of the drinker tip for create a fluid-tight seal.
